(19) United States
(12) Patent Application Publication
(10) Pub. No.: US 2021/0089926 A1
(43) Pub. Date: Mar. 25, 2021

(54) MACHINE LEARNING METHOD AND MACHINE LEARNING APPARATUS

(71) Applicant: YAMAHA CORPORATION, Hamamatsu-shi (JP)

(72) Inventors: Hiroaki NAKAJIMA, Hamamatsu-shi (JP); Yu TAKAHASHI, Hamamatsu-shi (JP)

(21) Appl. No.: 17/112,135

(22) Filed: Dec. 4, 2020

Related U.S. Application Data
(63) Continuation of application No. PCT/JP2019/022825, filed on Jun. 7, 2019.
(60) Provisional application No. 62/681,685, filed on Jun. 7, 2018.

(30) Foreign Application Priority Data
Aug. 2, 2018 (JP) 2018-145980

(51) Int. Cl. G06N 3/08; G10L 25/30; G06N 3/04

(52) U.S. Cl. CPC G06N 3/084; G06N 3/04; G10L 25/30

(57) ABSTRACT

A machine learning apparatus includes a memory storing instructions and a processor that implements the stored instructions to execute a plurality of tasks. The tasks include an obtaining task that obtains a mixture signal containing a first component and a second component, a first generating task that generates a first signal that emphasize the first component inputting a mixture signal to a neural network, a second generating task that generates a second signal by modifying the first signal, a calculating task that calculates an evaluation index from the second signal, and a training task that trains the neural network with the evaluation index.

### CROSS REFERENCE TO RELATED APPLICATIONS

This application is a continuation of PCT application No. PCT/JP2019/022825, which was filed on Jun. 7, 2019 based on and claims the benefit of priorities of U.S. Provisional Application No. 62/681,685 filed on Jun. 7, 2018 and Japanese Patent Application No. 2018-145980 filed on Aug. 2, 2018, the contents of which are incorporated herein by reference in its entirety.

### BACKGROUND OF THE INVENTION

### 1. Field of the Invention

The present disclosure relates to machine learning of a neural network.

### 2. Description of the Related Art

Signal processing techniques for generating a signal in which a particular component (hereinafter referred to as a “target component”) is emphasized from a mixture signal in which plural components are mixed together have been proposed conventionally. For example, Non-patent document 1 discloses a technique for emphasizing a target component in a mixture signal utilizing a neural network. Machine learning of a neural network is performed so that an evaluation index representing the difference between an output signal of the neural network and a correct signal representing a known target component is optimized.

Non-patent document 1: Y. Koizumi et al., “DNN-based Source Enhancement Self-optimized by Reinforcement Learning Using Sound Quality Measurements,” in Proc. ICASSP, 2017, pp. 81-85.

In a real situation in which a technique for emphasizing a target component is utilized, various kinds of modification processing such as adjustment of the frequency characteristic are performed on a signal in which a target component has been emphasized by a neural network. In the conventional technique in which an evaluation index that reflects an output signal of the neural network is used for machine learning, the neural network is not always trained so as to become optimum for total processing including processing for emphasizing a target component and downstream modification processing.

### SUMMARY OF INVENTION

In view of the above circumstances in the art, and an object of the disclosure is therefore to properly train a neural network that emphasizes a particular component of a mixture signal.

To attain the above object, a machine learning method executable by a computer according to one aspect of the disclosure includes: obtaining a mixture signal containing a first component and a second component; generating a first signal that emphasizes the first component by inputting the mixture signal to a neural network; generating a second signal by modifying the first signal; calculating an evaluation index from the second signal; and training the neural network with the evaluation index to emphasize the first component of the mixture signal.

A machine learning apparatus according to another aspect of the disclosure includes a memory storing instructions and a processor that implements the stored instructions to execute a plurality of tasks, the tasks including: a first generating task that generates a first signal that emphasize the first component inputting a mixture signal to a neural network; a second generating task that generates a second signal by modifying the first signal; a calculating task that calculates an evaluation index from the second signal; and a training task that trains the neural network with the evaluation index.

### BRIEF DESCRIPTION OF DRAWINGS

FIG. 1 is a block diagram showing an example configuration of a signal processing apparatus according to a first embodiment of the present disclosure;

FIG. 2 is a block diagram showing an example functional configuration of the signal processing apparatus according to the first embodiment;

FIG. 3 illustrates a matrix A that is used for calculating a target component St;

FIG. 4 illustrates orthogonal projection of an inference signal S;

FIG. 5 is a graph showing a relationship between a signal-to-distortion ratio R(γ) and a constant γ that represents a mixing ratio between the target component St and a residual component Sr;

FIG. 6 is a flowchart illustrating a specific procedure of machine learning;

FIG. 7 shows measurement results of the signal-to-distortion ratio and the signal-to-interference ratio:

FIG. 8 shows another set of measurement results of the signal-to-distortion ratio and the signal-to-interference ratio;

FIG. 9 shows a further set of measurement results of the signal-to-distortion ratio and the signal-to-interference ratio;

FIG. 10 shows a waveform of a first component:

FIG. 11 shows a waveform of an audio signal as processed in Comparative Example 2;

FIG. 12 shows a waveform of an audio signal as processed in the first embodiment;

FIG. 13 is a block diagram showing an example functional configuration of a signal processing apparatus according to a second embodiment; and

FIG. 14 is a flowchart illustrating a specific procedure of machine learning in the second embodiment.

### DETAILED DESCRIPTION OF THE EXEMPLARY EMBODIMENTS

### Embodiment 1

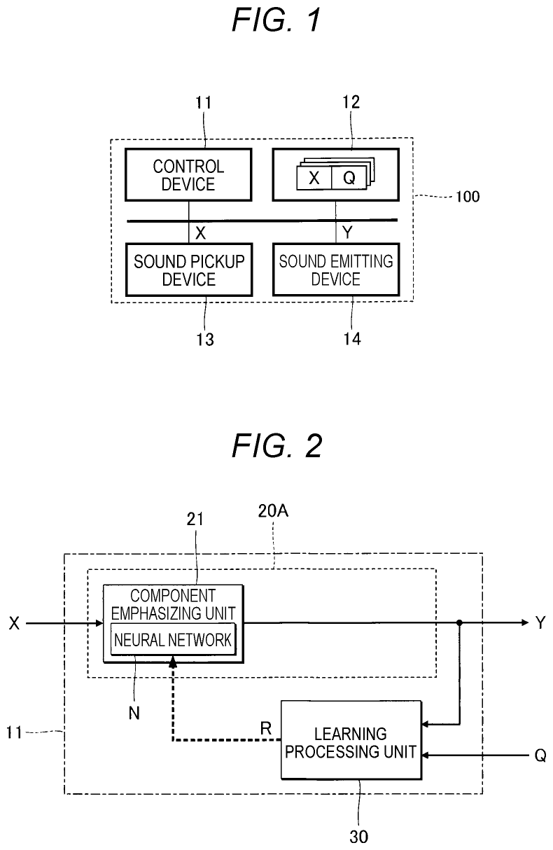

FIG. 1 is a block diagram showing an example configuration of a signal processing apparatus 100 according to a first embodiment of the present disclosure. The signal processing apparatus 100 is a sound processing apparatus that generates an audio signal Y from an audio signal X. The audio signal X is a mixture signal containing a first component and a second component. The first component is a signal component representing a voice uttered by, for example, singing a particular musical piece and the second component is a signal component representing, for example, an accompaniment sound of the musical piece. The audio signal Y is a signal in which the first component of the audio signal X is emphasized with respect to its second component (i.e., a signal in which the second component is suppressed with respect to the first component).

As is understood from the above, the signal processing apparatus 100 according to the first embodiment emphasizes a particular, first component among plural components contained in an audio signal X. More specifically, the signal processing apparatus 100 generates an audio signal Y representing a singing voice from an audio signal X representing a mixed sound of the singing voice and an accompaniment sound. The first component is a target component as a target of emphasis and the second component is a non-target component other than the target component.

As shown in FIG. 1, the signal processing apparatus 100 according to the first embodiment is implemented as a computer system that is equipped with a control device 11, a storage device 12, a sound pickup device 13, and a sound emitting device 14. Any of various information terminals such as a cellphone, a smartphone or a personal computer is used as the signal processing apparatus 100.

The control device 11, which is composed of one or more processing circuits such as a CPU (central processing unit), performs various kinds of calculation processing and control processing. The storage device 12, which is a memory formed by a known recording medium such as a magnetic recording medium or a semiconductor recording medium, stores programs to be run by the control device 11 and various kinds of data to be used by the control device 11. The storage device 12 may be a combination of plural kinds of recording media A portable storage circuit that can be attached to and detached from the signal processing apparatus 100 or an external storage device (e.g., online storage) with which the signal processing apparatus 100 can communicate over a communication network can be used as the storage device 12.

The sound pickup device 13 is a microphone for picking up sound around it. The sound pickup device 13 employed in the first embodiment generates an audio signal X by picking up a mixed sound having a first component and a second component. For the sake of convenience, an A/D converter for converting the analog audio signal X into a digital signal is omitted in FIG. 1. Alternatively, the sound pickup device 13 may be provided separately from the signal processing apparatus 100 and connected to it by wire or wirelessly. That is, the sound pickup device 13 need not always be provided inside the signal processing apparatus 100.

The sound emitting device 14 reproduces a sound represented by an audio signal Y that is generated from the audio signal X. That is, the sound emitting device 14 reproduces a first-component-emphasized sound. For example, a speaker(s) or headphones are used as the sound emitting device 14. For the sake of convenience, a D/A converter for converting the digital audio signal Y into an analog signal and an amplifier for amplifying the audio signal Y are omitted in FIG. 1. Alternatively, the sound emitting device 14 may be provided separately from the signal processing apparatus 100 and connected to it by wire or wirelessly. That is, the sound emitting device 14 need not always be provided inside the signal processing apparatus 100.

FIG. 2 is a block diagram showing an example functional configuration of the signal processing apparatus 100. As shown in FIG. 2, the control device 11 employed in the first embodiment realizes plural functions (signal processing unit 20A and learning processing unit 30) for generating an audio signal Y from an audio signal X by running programs stored in the storage device 12. The functions of the control device 11 may be realized by plural devices (i.e., systems) that are separate from each other or all or part of the functions of the control device 11 may be realized by a dedicated electronic circuit.

The signal processing unit 20A generates an audio signal Y from an audio signal X generated by the sound pickup device 13. The audio signal Y generated by the signal processing unit 20A is supplied to the sound emitting device 14 and a first-component-emphasized sound is reproduced by the sound emitting device 14. As shown in FIG. 2, the signal processing unit 20A employed in the first embodiment includes a component emphasizing unit 21.

The component emphasizing unit 21 generates an audio signal Y from an audio signal X. As shown in FIG. 2, a neural network N is used when the component emphasizing unit 21 generates an audio signal Y That is, the component emphasizing unit 21 generates an audio signal Y by inputting the audio signal X to the neural network N. The neural network N is a statistical inference model for generating an audio signal Y from an audio signal X. More specifically, a deep neural network (DNN) consisting of multiple layers (four or more layers) is employed as the neural network N. The neural network N is realized as a combination of programs (e.g., a program module that constitutes artificial intelligence software) for causing the control device 11 to perform calculations for outputting a time series of samples of an audio signal Y on the basis of a received time series of samples of an audio signal X and plural coefficients used for the calculations.

The learning processing unit 30 shown in FIG. 2 trains the neural network N using plural training data D. The learning processing unit 30 sets plural coefficients that define the neural network N by supervised machine learning using plural training data D. The plural coefficients that have been set by the machine learning are stored in the storage device 12.

The plural training data D are prepared before generation of an audio signal Y from an unknown audio signal X generated by the sound pickup device 13 and stored in the storage device 12. As exemplified in FIG. 1, each of the plural training data D consists of an audio signal X and a correct signal Q. The audio signal X of each training data D is a known signal containing a first component and a second component. The correct signal Q of each training data D is a known signal representing the first component contained in the audio signal X of the training data D. That is, the correct signal Q is a signal that does not contain the second component, in other words, a signal (clean signal) obtained by extracting the first component from the audio signal X in an ideal manner.

More specifically, the plural coefficients of the neural network N are updated repeatedly so that the audio signal Y that is output when the audio signal X of each training data D is input to a tentative neural network N comes closer to the correct signal Q of the training data D gradually. A neural network N whose coefficients have been updated using the plural training data D is used as a machine-learned neural network N by the component emphasizing unit 21. Thus, a neural network N that has been subjected to the machine learning by the learning processing unit 30 outputs an audio signal Y that is statistically suitable for an unknown audio signal X generated by the sound pickup device 13 according to latent relationships between the audio signals X and the correct signals Q of the plural training data D. As described above, the signal processing apparatus 100 according to the first embodiment functions as a machine learning apparatus for causing the neural network N to learn an operation of emphasizing a first component of an audio signal X.

In doing machine learning, the learning processing unit 30 calculates an index (hereinafter referred to as an “evaluation index”) of errors between a correct signal Q of training data D and an audio signal Y generated by a tentative neural network N and trains the neural network N so that the evaluation index is optimized. The learning processing unit 30 employed in the first embodiment calculates, as the evaluation index (loss function), a signal-to-distortion ratio (SDR) R between a correct signal Q and an audio signal Y. In other words, the signal-to-distortion ratio R is an index indicating to what degree the tentative neural network N is appropriate as a means for emphasizing a first component of an audio signal X.

For example, the signal-to-distortion ratio R is given by the following Equation (1):

$$\begin{matrix}[ Equation 1 ] & \\ R = 10 {log}_{10} \frac{{\vert {S}_{t} \vert}^{2}}{{\vert S - {S}_{t} \vert}^{2}} & ( 1 )\end{matrix}$$

The symbol “| |²” means power of a signal concerned. The symbol “S” in Equation (1) is an M-dimensional vector (hereinafter referred to as an “inference signal”) having, as elements, a time series of N samples of an audio signal Y that is output from the neural network N. The symbol “M” is a natural number that is larger than or equal to 2. The symbol “St” (t: target) in Equation (1) is an M-dimensional vector (hereinafter referred to as a “target component”) that is given by the following Equation (2). The symbol “T” in Equation (2) means matrix transposition.

[Equation 2]

Sₜ=A(A^{T}A)⁻¹A^{T}S (2)

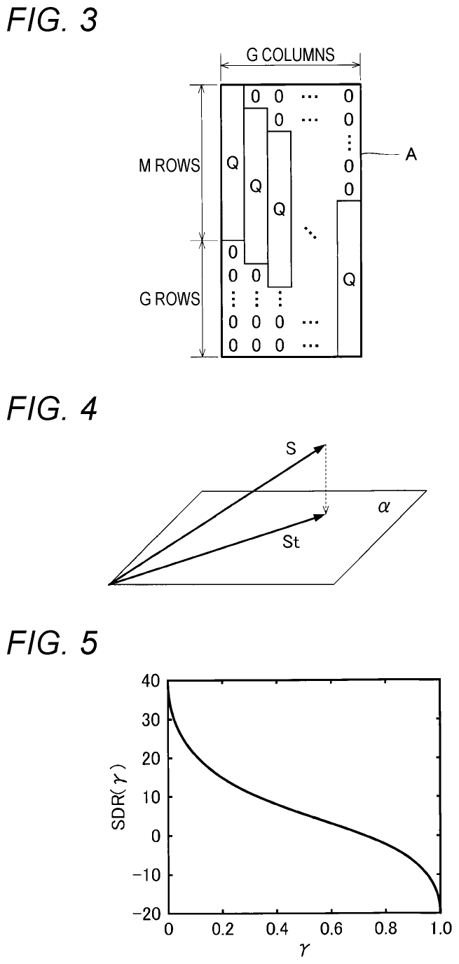

Each correct signal Q is represented by an M-dimensional vector having, as elements, a time series of N samples of a first component. As shown in FIG. 3, the symbol “A” in Equation (2) is an asymmetrical Toeplitz matrix of (M+G) rows×G columns (G: natural number) that is an array of vectors each representing a correct signal Q of training data D. As seen from Equation (2) and FIG. 4, the target component St means an orthogonal projection of the inference signal S onto a linear space a that is defined by the correct signal Q.

The inference signal S is given as a mixture of the target component St and a residual component Sr (r: residual). For example, the residual component Sr includes a noise component and an algorithm distortion component. The numerator |St|² in Equation (1) which represents the signal-to-distortion ratio R corresponds to a component amount of the target component St (i.e., first component) included in the inference signal S. The denominator |S−St|² (in Equation (1) corresponds to a component amount of the residual component Sr included in the inference signal S. The learning processing unit 30 employed in the first embodiment calculates a signal-to-distortion ratio R by substituting an audio signal Y (inference signal S) generated by a tentative neural network N and the correct signal Q of the training data D into the above Equations (1) and (2).

The inference signal S is given by the following Equation (3) as a weighted sum of the target component St and the residual component Sr:

[Equation 3]

S=\sqrt{1−γ²}Sₜ+γSᵣ (3)

The constant γ in Equation (3) is a non-negative value that is smaller than or equal to 1 (0≤γ≤1). Assuming that the absolute value |S| of the inference signal S, the absolute value |St| of the target component St and the absolute value |Sr| of the residual component Sr are equal to 1 and considering the fact that the target component St and the residual component Sr are perpendicular to each other, the following Equation (4) is derived which expresses the signal-to-distortion ratio R as a function of the constant γ:

$$\begin{matrix}[ Equation 4 ] & \\ R ( γ ) = 10 {log}_{10} \frac{1 - {γ}^{2}}{{γ}^{2}} & ( 4 )\end{matrix}$$

FIG. 5 is a graph showing a relationship between the signal-to-distortion ratio R(γ) that is given by Equation (4) and the constant γ. As seen from FIG. 5, the inference signal S comes closer to the target component St as the constant γ comes closer to 0. Thus, a relationship holds that the inference signal S (audio signal Y) comes closer to the target component St as the signal-to-distortion ratio R increases. That is, as described above, the value of the signal-to-distortion ratio R increases as an audio signal Y that is output from the neural network N comes closer to a correct signal Q.

In view of the above, the learning processing unit 30 trains the neural network N so that the signal-to-distortion ratio R increases (ideally, it is maximized). More specifically, the learning processing unit 30 employed in the first embodiment updates the plural coefficients of a tentative neural network N so that the signal-to-distortion ratio R is increased by error back propagation utilizing automatic differentiation of the signal-to-distortion ratio R. That is, the plural coefficients of a tentative neural network N is updated so that the proportion of the first component is increased by deriving a derivative of the signal-to-distortion ratio R through expansion utilizing the chain rule. An audio signal Y is generated from an unknown audio signal X generated by the sound pickup device 13 using a neural network N that has learned an operation for emphasizing a first component through the above-described machine learning. The machine learning utilizing automatic differentiation is disclosed in, for example, A. G. Baydin et al., “Automatic Differentiation in Machine Learning: a Survey,” arXiv preprint arXiv: 1502.05767, 2015.

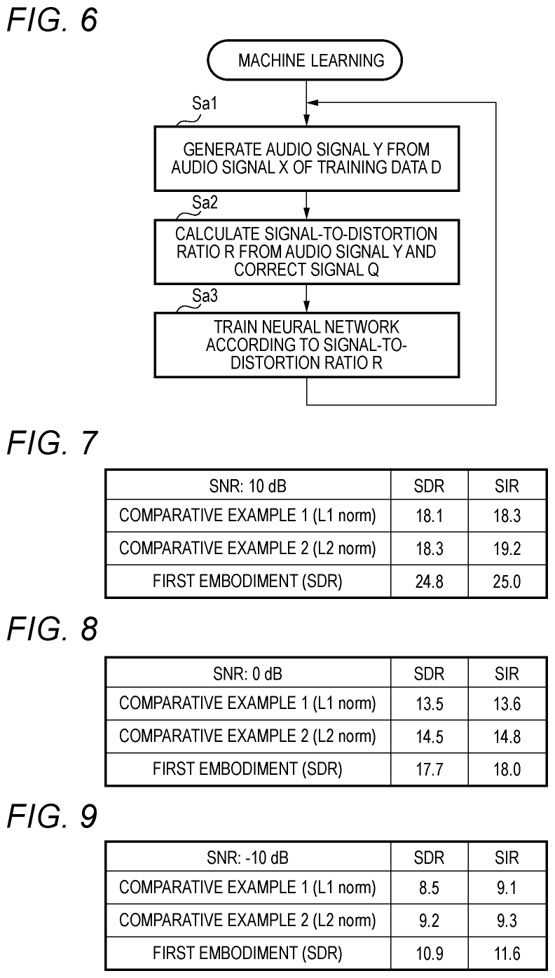

FIG. 6 is a flowchart illustrating a specific procedure (machine learning method) of machine learning. The machine learning shown in FIG. 6 is started triggered by a user instruction, for example. Upon the start of the machine learning, at step Sa1 the component emphasizing unit 21 generates an audio signal Y by inputting an audio signal X of desired one training data D to a tentative neural network N. At step Sa2, the learning processing unit 30 calculates a signal-to-distortion ratio R on the basis of the audio signal Y and the correct signal Q of the training data D. At step Sa3, the learning processing unit 30 updates the coefficients of the neural network N so that the signal-to-distortion ratio R is increased. As described above, error back propagation utilizing automatic differentiation is used to update the coefficients according to the signal-to-distortion ratio R. A neural network N that has experienced machine learning is generated by executing steps Sa1-Sa3 repeatedly for plural training data D.

As described above, in the first embodiment, the neural network N is trained by machine learning that uses the signal-to-distortion ratio R as an evaluation index. As a result, in the first embodiment, as described below in detail, a first component of an audio signal X can be emphasized with higher accuracy than in a conventional method in which an L1 norm, an L2 norm, or the like is used as an evaluation index.

FIGS. 7 to 9 show sets of results of measurements of the signal-to-distortion ratio (SDR) and the signal-to-interference ratio (SIR) of an audio signal Y as processed by the component emphasizing unit 21 in plural cases that are different from each other in the signal-to-noise ratio (SNR) of an audio signal X. Comparative Example 1 is a case that the L1 norm was used as an evaluation index of machine learning and Comparative Example 2 is a case that the L2 norm was used as an evaluation index of machine learning. As seen from FIGS. 7 to 9, in the first embodiment in which the signal-to-distortion ratio R is used as an evaluation index, the signal-to-interference ratio, not to mention the signal-to-distortion ratio, is improved from Comparative Examples 1 and 2 irrespective of the magnitude of the signal-to-noise ratio of the audio signal X.

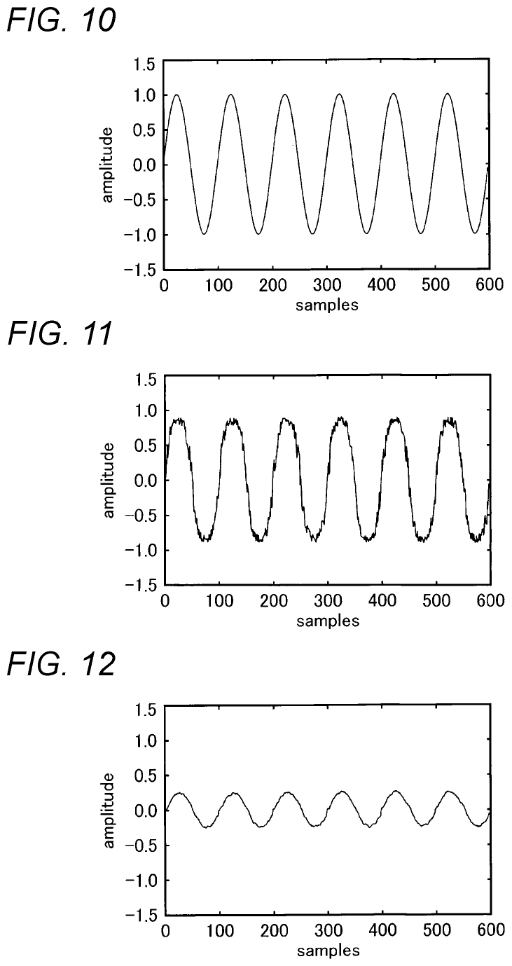

For the sake of convenience, assume an audio signal X containing a first component shown in FIG. 10. FIGS. 11 and 12 show waveforms of audio signals Y as processed that correspond to the audio signal X shown in FIG. 10, respectively. The waveform of the audio signal Y shown in FIG. 1I is a waveform generated by the configuration of Comparative Example 2 in which the L2 norm is used in the machine learning. The waveform of the audio signal Y shown in FIG. 12 is a waveform generated by the configuration of the first embodiment in which the signal-to-distortion ratio R is used in machine learning. FIG. 10 corresponds to an ideal waveform of the audio signal Y. In Comparative Example 2 and the first embodiment, a case is assumed that an audio signal X whose signal-to-noise ratio is 10 dB is processed.

In Comparative Example 2, the neural network N is given only a tendency that sample value approximation is made between an audio signal Y and a correct signal Q and is not given a tendency that a noise component contained in the audio signal Y is suppressed. That is, in Comparative Example 2, a tendency that a first component is approximated using a noise component of an audio signal X is not eliminated even if it exists. Thus, as seen from FIG. 11, in Comparative Example 2, it is a probable that an audio signal Y containing a large noise component is generated. In contrast to Comparative Example 2, in the first embodiment in which the neural network N is subjected to machine learning using the signal-to-distortion ratio R as an evaluation index, the neural network N is trained so that not only is waveform approximation made between an audio signal Y and a correct signal Q but also a noise component contained in the audio signal Y is suppressed. As a result, as seen from FIG. 12, the first embodiment can generate an audio signal Y in which a noise component is suppressed effectively. It is noted that in the first embodiment there may occur a case that an audio signal Y is different from an audio signal X in amplitude.

### Embodiment 2

A second embodiment of the disclosure will be described. In the following description, constituent elements having the same ones in the first embodiment will be given the same reference symbols as the latter and may not be described in detail as appropriate.

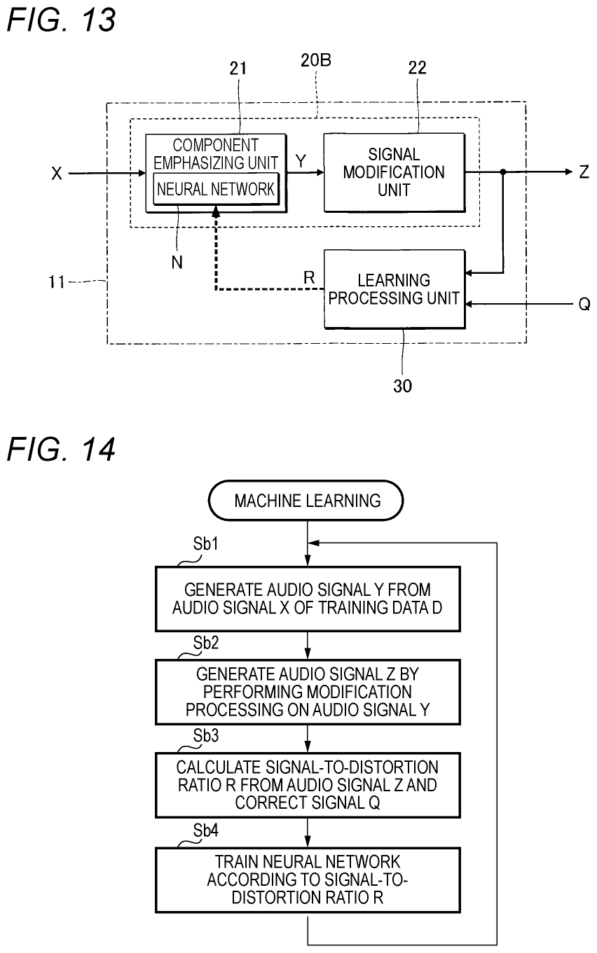

FIG. 13 is a block diagram showing an example functional configuration of a signal processing apparatus 100 according to a second embodiment. As shown in FIG. 13, the signal processing apparatus 100 according to the second embodiment is configured in such a manner that the signal processing unit 20A employed in the first embodiment is replaced by a signal processing unit 20B. The signal processing unit 20B generates an audio signal Z from an audio signal X generated by the sound pickup device 13. Like an audio signal Y, the audio signal Z is a signal in which the first component of the audio signal X is emphasized with respect to its second component (i.e., a signal in which the second component is suppressed with respect to the first component).

The signal processing unit 20B employed in the second embodiment is equipped with a component emphasizing unit 21 and a signal modification unit 22. The configuration and the operation of the component emphasizing unit 21 are the same as in the first embodiment. That is, the component emphasizing unit 21 includes a neural network N subjected to the mechanical learning and generates, from an audio signal X, an audio signal Y (an example of a term “first signal”) in which a first component is emphasized.

The signal modification unit 22 generates an audio signal Z (an example of a term “second signal”) by modifying an audio signal Y generated by the component emphasizing unit 21. The processing (hereinafter referred to as “modification processing”) performed by the signal modification unit 22 is desired signal processing to change a signal characteristic of an audio signal Y More specifically, the signal modification unit 22 performs filtering processing of changing the frequency characteristic of an audio signal Y. For example, an FIR filter (finite impulse response) filter that generates an audio signal Z by giving a particular frequency characteristic to an audio signal Y is used as the signal modification unit 22. In other words, the processing performed by the signal modification unit 22 is effect adding processing (effector) for adding any of various acoustic effects to an audio signal Y. The modification processing performed by the signal modification unit 22 employed in the first embodiment is expressed by a linear operation. The audio signal Z generated by the modification processing is supplied to the sound emitting device 14. That is, a sound in which the first component of the audio signal X is emphasized and is given a particular frequency characteristic is reproduced by the sound emitting device 14.

The learning processing unit 30 employed in the first embodiment trains the neural network N according to an evaluation index calculated from an audio signal Y generated by the component emphasizing unit 21. Unlike in the first embodiment, the learning processing unit 30 employed in the second embodiment trains the neural network N of the component emphasizing unit 21 according to an evaluation index calculated from an audio signal Z as processed by the signal modification unit 22. As in the first embodiment, plural training data D stored in the storage device 12 are used in the machine learning performed by the learning processing unit 30. As in the first embodiment, each training data D used in the second embodiment includes an audio signal X and a correct signal Q. The audio signal X is a known signal containing a first component and a second component. The correct signal Q of each training data D is a known signal generated by performing modification processing on the first component contained in the audio signal X of the training data D.

The learning processing unit 30 updates, sequentially, the plural coefficients defining the neural network N of the component emphasizing unit 21 so that an audio signal Z that is output from the signal processing unit 20B when it receives the audio signal X of each training data D comes closer to the correct signal Q of the training data D. Thus, the neural network N that has been subjected to the machine learning by the learning processing unit 30 outputs an audio signal Z that is statistically suitable for an unknown audio signal X generated by the sound pickup device 13 according to latent relationships between the audio signals X and the correct signals Q of the plural training data D.

More specifically, the learning processing unit 30 employed in the second embodiment calculates an evaluation index of an error between a correct signal Q of training data D and an audio signal Z generated by signal processing unit 20B and trains the neural network N so that the evaluation index is optimized. The learning processing unit 30 employed in the second embodiment calculates, as the evaluation index, a signal-to-distortion ratio R between the correct signal Q and the audio signal Z.

Whereas in the first embodiment an audio signal Y that is output from the component emphasizing unit 21 is used as an inference signal S of Equation (1), in the second embodiment a time series of N samples representing an audio signal Z as subjected to the modification processing by the signal modification unit 22 is used as an inference signal S of Equation (1). That is, the learning processing unit 30 employed in the second embodiment calculates a signal-to-distortion ratio R by substituting an audio signal Z (inference signal S) generated by a tentative neural network N and the signal modification unit 22 and the correct signal Q of the training data D into the above-mentioned Equations (1) and (2).

As described above, the modification processing performed by the signal modification unit 22 employed in the second embodiment is expressed by a linear operation. Thus, error back propagation utilizing automatic differentiation can be used for the machine learning of the neural network N. That is, as in the first embodiment, the learning processing unit 30 employed in the second embodiment updates the plural coefficients of a tentative neural network N so that the signal-to-distortion ratio R is increased by error back propagation utilizing automatic differentiation of the signal-to-distortion ratio R. Incidentally, coefficients (e.g., plural coefficients that define an FIR filter) relating to the modification processing of the signal modification unit 22 are fixed values and are not updated by the machine learning by the learning processing unit 30.

FIG. 14 is a flowchart illustrating a specific procedure (machine learning method) of machine learning in the second embodiment. The machine learning shown in FIG. 14 is started triggered by a user instruction, for example. Upon the start of the machine learning, at step Sb1 the component emphasizing unit 21 generates an audio signal Y by inputting an audio signal X of desired one training data D to a tentative neural network N. At step Sb2, the signal modification unit 22 generates an audio signal Z by performing modification processing on the audio signal Y generated by the component emphasizing unit 21. At step Sb3, the learning processing unit 30 calculates a signal-to-distortion ratio R on the basis of the audio signal Y and the correct signal Q of the training data D. At step SM, the learning processing unit 30 updates the coefficients of the tentative neural network N so that the signal-to-distortion ratio R is increased. Error back propagation utilizing automatic differentiation is used to update the coefficients according to the signal-to-distortion ratio R. A neural network N that has experienced machine learning is generated by executing steps Sb1-Sb4 repeatedly for plural training data D.

In the second embodiment, the neural network N is trained by machine learning that uses the signal-to-distortion ratio R as an evaluation index. Thus, as in the first embodiment, a first component of an audio signal X can be emphasized with high accuracy. Furthermore, in the second embodiment, the neural network N is trained according to an evaluation index (more specifically, signal-to-distortion ratio R) calculated from an audio signal Z generated by modification processing by the signal modification unit 22. As a result, the second embodiment provides an advantage that the neural network N is trained so as to be suitable for the overall processing of generating an audio signal Z from an audio signal X via an audio signal Y in contrast to the first embodiment in which the neural network N is trained according to an evaluation index calculated from an audio signal Y that is output from the component emphasizing unit 21.

### <Modifications>

Specific modifications of each of the above embodiments will be described below. Two or more desired ones selected from the following modifications may be combined together as appropriate within the confines that no discrepancy occurs between them.

(1) Although in each of the above embodiments the signal-to-distortion ratio R is used as an example evaluation index of the mechanical learning, the evaluation index used in the second embodiment is not limited to the signal-to-distortion ratio R. For example, any known index such as the L1 norm or the L2 norm between an audio signal Z and a correct signal Q may be used as the evaluation index in machine learning. Furthermore, Itakura-Saito divergence or STOI (short-time objective intelligibility) may be used as the evaluation index. Machine learning using STOI is described in detail in, for example, X. Zhang et al., “Training Supervised Speech Preparation System to STOI and PESQ Directly,” in Proc. ICASSP, 2018, pp. 5,374-5,378.

(2) Although each of the above embodiments is directed to the processing performed on an audio signal, the target of the processing of the signal processing apparatus 100 is not limited to an audio signal. For example, the signal processing apparatus 100 according to each of the above embodiments may be applied to process a detection signal indicating a detection result of any of various detection devices. For example, the signal processing apparatus 100 or 100A may be used for attaining emphasis of a target component and suppression of a noise component of a detection signal that is output from any of various detection devices such as an acceleration sensor and a geomagnetism sensor.

(3) In each of the above embodiments, the signal processing apparatus 1 performs both of machine learning on the neural network N and signal processing on an unknown audio signal X using a neural network N as subjected to machine learning. However, the signal processing apparatus 100 or 100A can also be realized as a machine learning apparatus for performing machine learning. A neural network N as subjected to machine learning by the machine learning apparatus is provided for an apparatus that is separate from the machine learning apparatus and used for signal processing for emphasizing a first component of an unknown audio signal X.

(4) The functions of the signal processing apparatus 100 or 100A according to each of the above embodiments is realized by cooperation between a computer (e.g., control device 11) and programs. In one mode of the disclosure, the programs are provided being stored in a computer-readable recording medium and then installed in the computer. An example of the recording medium is a non-transitory recording medium a typical example of which is an optical recording medium (optical disc) such as a CD-ROM. However, it may be a known, any type of recording medium such as a semiconductor recording medium or a magnetic recording medium. The term “non-transitory recording medium” means any recording medium for storing signals excluding a transitory, propagating signal and does not exclude volatile recording media. Furthermore, the programs may be provided for the computer through delivery over a communication network.

(5) What mainly runs the artificial intelligence software for realizing the neural network N is not limited to a CPU. For example, a neural network processing circuit (NPU: neural processing unit) such as a tensor processing unit or a neural engine may run the artificial intelligence software. Alternatively, plural kinds of processing circuits selected from the above-mentioned examples may execute the artificial intelligence software in cooperation.

(6) As an actual use of this disclosure, only a vocal sound or only an accompaniment sound of a musical piece can be extracted from a recording sound signal of a vocal song with the accompaniment sound of the musical piece. Also, a speech sound can be extracted from a recording sound of a speech with a background noise by eliminating the background noise.

### <Additional Remarks>

For example, the following configurations are recognized from the above embodiments:

A machine learning method according to one mode of the disclosure generates a first signal in which a first component is emphasized by applying a neural network to process a mixture signal containing the first component and a second component; generating a second signal by performing modification on the first signal; and training the neural network according to an evaluation index calculated from the second signal. More specifically, the neural network is caused to learn an operation of emphasizing a first component of a mixture signal. In this mode, a first signal in which a first component is emphasized is generated by the neural network and a second signal is generated by modifying the first signal. The neural network is trained under the above pieces of processing according to an evaluation index calculated from a second signal generated by the modification. As a result, the neural network can be trained so as to become suitable for the overall processing (for obtaining a second signal from a mixture signal via a first signal) in contrast to the configuration in which the neural network is trained according to an evaluation index calculated from a first signal.

In an example (second mode) of the first mode, the modification performed on the first signal is a linear operation and in the above-described training the neural network is trained by error back propagation utilizing automatic differentiation. In this mode, since the neural network is trained by error back propagation utilizing automatic differentiation, the neural network can be trained efficiently even in a case that the processing of generating a second signal from a mixture signal is expressed by a complex function.

In an example (third mode) of the first mode or the second mode, the modification performed on the first signal using an FIR filter. In an example (fourth mode) of any of the first mode to the third mode, the evaluation index is a signal-to-distortion ratio that is calculated from the second signal and a correct signal representing the first component. In these modes, since the neural network is trained utilizing the signal-to-distortion ratio that is calculated from the second signal and the correct signal representing the first component, a second signal can be generated in which the first component is emphasized properly by suppressing a noise component sufficiently.

The concept of the disclosure can also be implemented as a machine learning apparatus that performs the machine learning method of each of the above mode or a program for causing a computer to perform the machine learning method of each of the above mode.

The machine learning method and the machine learning apparatus according to the disclosure can properly train a neural network that emphasizes a particular component of a mixture signal.

What is claimed is:

1. A machine learning method executable by a computer, the machine learning method comprising:
obtaining a mixture signal containing a first component and a second component;
generating a first signal that emphasizes the first component by inputting the mixture signal to a neural network;
generating a second signal by modifying the first signal;
calculating an evaluation index from the second signal; and
training the neural network with the evaluation index to emphasize the first component of the mixture signal.

2. The machine learning method according to claim 1, wherein the generating of the second signal modifies the first signal to change a signal characteristic of the first signal.

3. The machine learning method according to claim 1, wherein the generating of the second signal modifies the first signal by applying an effect to the first signal.

4. The machine learning method according to claim 1, wherein:
the generating of the second signal modifies the first signal by performing a linear signal processing to the first signal, and
the training trains the neural network by error back propagation utilizing automatic differentiation.

5. The machine learning method according to claim 1, wherein the generating of the second signal modifies the first signal with a FIR filter.

6. The machine learning method according to claim 1, wherein the calculating calculates the evaluation index, which is a signal-to-distortion ratio, from the second signal and a correct signal representing the first component.

7. The machine learning method according to claim 1, wherein the mixture signal is an audio signal generated by a sound pickup device.

8. The machine learning method according to claim 1, wherein the mixture signal is a detection signal indicating a detection result of a detection device.

9. A machine learning apparatus comprising:
a memory storing instructions; and
a processor that implements the stored instructions to execute a plurality of tasks, including:
an obtaining task that obtains a mixture signal containing a first component and a second component;
a first generating task that generates a first signal that emphasize the first component inputting a mixture signal to a neural network;
a second generating task that generates a second signal by modifying the first signal;
a calculating task that calculates an evaluation index from the second signal; and
a training task that trains the neural network with the evaluation index.

10. The machine learning apparatus according to claim 9, wherein:
the second generating task modifies the first signal by performing linear signal processing to the first signal, and
the training task trains the neural network by error back propagation utilizing automatic differentiation.

11. The machine learning apparatus according to claim 9, wherein the second generating task modifies the first signal with a FIR filter.

12. The machine learning apparatus according to claim 9, wherein the calculating task calculates the evaluation index, which is a signal-to-distortion ratio, from the second signal and a correct signal representing the first component.

13. A non-transitory computer-readable storage medium storing a program executable by a computer to execute a machine learning method comprising:
obtaining a mixture signal containing a first component and a second component;
generating a first signal that emphasizes the first component by inputting the mixture signal to a neural network;
generating a second signal by modifying the first signal;
calculating an evaluation index from the second signal; and
training the neural network with the evaluation index to emphasize the first component of the mixture signal.
